(19) United States
(12) Patent Application Publication
(10) Pub. No.: US 2009/0046745 A1
(43) Pub. Date: Feb. 19, 2009

(54) APPARATUS FOR TRANSMITTING AND RECEIVING DATA WITH VARIOUS DATA CAPACITIES AT HIGH SPEED

(75) Inventors: Jong Yoon Shin, Daejeon (KR); Je Soo Ko, Daejeon (KR); Jong Ho Kim, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/120,132

(22) Filed: May 13, 2008

(30) Foreign Application Priority Data
Aug. 16, 2007 (KR) 10-2007-82198

(51) Int. Cl. H04L 29/02; H04J 3/04

(52) U.S. Cl. 370/535; 370/537

(57) ABSTRACT

There is provided an apparatus for transmitting and receiving data with various data capacity at high speed. The apparatus for transmitting and receiving data includes a client signal interface block converting client signals being received through media into a high-capacity electrical signal and selectively interfacing the converted high-capacity electrical signal through high-speed multi-channel; a framer receiving the selectively interfaced electrical signal from the client signal interface block and multiplexing and mapping the received electrical signal into 40 G multi-channel frame signals; and a SERDES & transceiver receiving the 40 G multi-channel frame signals from the framer, multiplexing the received multi-channel frame signals with the 40 G serial signals and transmitting the multiplexed 40 G serial signals. The apparatus for transmitting and receiving data may be useful to decrease its space and stably receive client signals by selectively interfacing various client signals with replacing the client signal interface blocks only, depending on the client signals to be supplied to the same transmitting/receiving apparatus.

### CROSS-REFERENCE TO RELATED APPLICATIONS

This application claims the priority of Korean Patent Application No. 2007-82198 filed on Aug. 16, 2007, in the Korean Intellectual Property Office, the disclosure of which is incorporated herein by reference.

### BACKGROUND OF THE INVENTION

1. Field of the Invention

The present invention relates to an apparatus for transmitting and receiving data at high speed (so-called a high-speed data transmitting/receiving apparatus), and more particularly, to an apparatus for transmitting and receiving data with various data capacity at high speed, the apparatus capable of receiving all kinds of various data having a gigabit or more data capacity, and selectively interfacing the data.

The present invention was supported by the Information Technology Research and Development (IT R&D) Program of Ministry of Information and Communication (MIC/IITA) [2006-S-060-1, OTH-based 40 G Multi-service Transmission Technology].

2. Description of the Related Art

With the evolution of networks, client signals having a high data capacity, such as an STM-64/OC-192 signal, an STM-16/OC-48 signal, GbE/10 GbE and SAN signals, may be transmitted/received through internet networks. Therefore, a problem is that each of data transmitting/receiving apparatuses should be designed, manufactured and handled according to the kind of client signals.

As described in the prior arts, a 10 G data transmitting apparatus, which may be reconstructed and reused by exchanging some of interface boards and resetting a hardware through a firmware when inputted client signals are changed in capacity, has been developed to solve the above problems. FIG. 1 is a diagram illustrating a conventional 10 G data transmitting/receiving apparatus that may be reconstructed according to the client signals.

Referring to FIG. 1, the conventional 10 G data transmitting/receiving apparatus includes a client signal interface block 30, a 10 G framer 20 and a 10 G SERDES & transceiver 10. The client signal interface block 30 is attachably/detachably coupled to the data transmitting/receiving apparatus, and includes a medium-electricity transducer 31 that is differently configured according to the connected client signals. The client signal interface block is composed of a medium-electricity transducer 31 and a client signal connector 32. The medium-electricity transducer 31 functions to convert a signal, inputted through media such as an optical cable, an electrical cable or a PCB wire, into a digital electrical signal and convert the inputted electrical signal into parallel data signals and recover a clock signal frome inputted electrical signal. The client signal connector 32 provides a means for transmitting/receiving a plurality of first clock signals (clock signals outputted from the 10 G framer 20), a plurality of second clock signals (clock signals outputted from the client signal interface block 30) and a plurality of data signals to/from the 10 G framer 20.

The 10 G framer 20 multiplexes or maps the client signals into 10 G signals, or takes its inverse operation.

The 10 G SERDES & transceiver 10 receives a 16-bit parallel data and a synchronous clock from the 10 G framer 20, converts the 16-bit parallel data into 10 G serial electrical signals using the synchronous clock and transmits the converted 10 G serial electrical signals, or takes its inverse operation.

That is to say, the 10 G SERDES & transceiver 10 has a configuration using a large number of clock signals synchronized with the data to transmit/receive the converted parallel data to/from the client signal interface block 30 or the 10 G framer 20 as known in the prior art. The 10 G SERDES & transceiver 10 has a configuration where a 16-bit parallel data signal is transmitted along with a clock signal at a 622 Mbps data rate to transmit a 10 G signal. Here, the 10 G SERDES & transceiver 10 should use a 64-bit parallel data signal to transmit a 40 G data at a 622 Mbps data rate. Similarly, when the 10 G SERDES & transceiver 10 transmits/receives a 10 G data signal in the form of 8-bit or 4-bit parallel data, a gigabit data signal should be transmitted/received along with a clock signal at a data rate twice or four times greater than conventional ones. The clock and the parallel data should synchronize with each other and be transmitted at a high speed with the increasing capacity of data to be transmitted as described above. Also, a skew problem caused by other data transmission delay per channel should be solved.

Some advantages may be obtained by decreasing the number of pins and reducing the volume of an apparatus, when to transmit an electrical signal through the high-speed serial channels rather than the conventional low-speed parallel channels along with clocks is used for the purpose of solving these problems. However, with the recent increasing demand for data transmission greater than the data transmission through serial channels, the data transmission through the high-speed serial channels has come to the data transmission in a parallel manner. Also since the kinds of high-capacity client signals to be received are increased with the increased possibility to receive more data capacity, the data transmitting/receiving apparatuses themselves should be exchanged according to the connected client signals. Therefore, the problem is that PCBs for the data transmitting/receiving apparatuses should be produced according to the client signals.

### SUMMARY OF THE INVENTION

The present invention is designed to solve the problems of the prior art, and therefore it is an object of the present invention to provide an apparatus for transmitting and receiving data at high speed capable of stably receiving various data having a high data capacity and selectively interfacing client signals at the same time.

Also, it is another object of the present invention to provide one apparatus for transmitting and receiving data at high speed capable of interfacing a transmission data with 160 G capacity, and also selectively interfacing 16 10 G client signals, 4 40 G client signals or one 160 G client signal when a 10 G SERDES (serializer/deserializer) is composed of 16 parallel channels.

According to an aspect of the present invention, there is provided an apparatus for transmitting and receiving data with various data capacities at high speed, including a client signal interface block converting various kinds of client signals being received through media into a high-capacity electrical signal and selectively interfacing the converted high-capacity electrical signal through high-speed multi-channel; a framer receiving the selectively interfaced electrical signal from the client signal interface block and multiplexing and mapping the received electrical signal into multi-channel frame signals; and a SERDES & transceiver receiving the generated multi-channel frame signals from the framer through the high-speed multi-channel, multiplexing the received multi-channel frame signals with the predetermined gigabit serial signals and transmitting the multiplexed gigabit serial signals.

In this case, the client signal interface block of the apparatus for transmitting and receiving data at high speed includes a medium-electricity transducer converting the client signals received through the media into the high-capacity electrical signal and converting the high-capacity electrical signal received from the framer into the client signal; and a client signal connector selectively transmitting the high-capacity electrical signal received from the medium-electricity transducer to the framer through the high-speed multi-channel, receiving a data signal outputted from the framer through the high-speed multi-channel and transmitting the received data signal to the medium/electricity transducer.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block view illustrating a configuration of a conventional apparatus for transmitting and receiving data at high speed which is used to transmit a 10 G data signal,

FIG. 2 is a block view illustrating a configuration of an apparatus for transmitting and receiving data at high speed according to one exemplary embodiment of the present invention which is used to transmit a data in 40 G capacity and able to be reconstructed through 2.5 G signal connection according to various client signals,

FIGS. 3 to 7 are block views illustrating schematic configurations of the apparatus for transmitting and receiving data at high speed according to one exemplary embodiment of the present invention which is used to transmit a data in 40 G capacity and able to be reconstructed to receive signals having various data capacities, and connections of their components,

FIG. 8 is a block view illustrating a configuration of an apparatus for transmitting and receiving data at high speed according to another exemplary embodiment of the present invention which is used to transmit a data in 40 G capacity and able to be reconstructed through 10 G signal connection according to various client signals,

FIGS. 9 to 11 are block views illustrating schematic configurations of the apparatus for transmitting and receiving data at high speed according to another exemplary embodiment of the present invention which is used to transmit a data in 40 G capacity and able to be reconstructed to receive signals having various data capacities, and connections of their components,

FIG. 12 is a block view illustrating a configuration of an optical transponder according to still another exemplary embodiment of the present invention that is used to receive 2.5 G, 10 G and 40 G client signals, map the received client signals into a 40 G transmission frame and transmit the 40 G transmission frame in the form of 40 G optical signal.

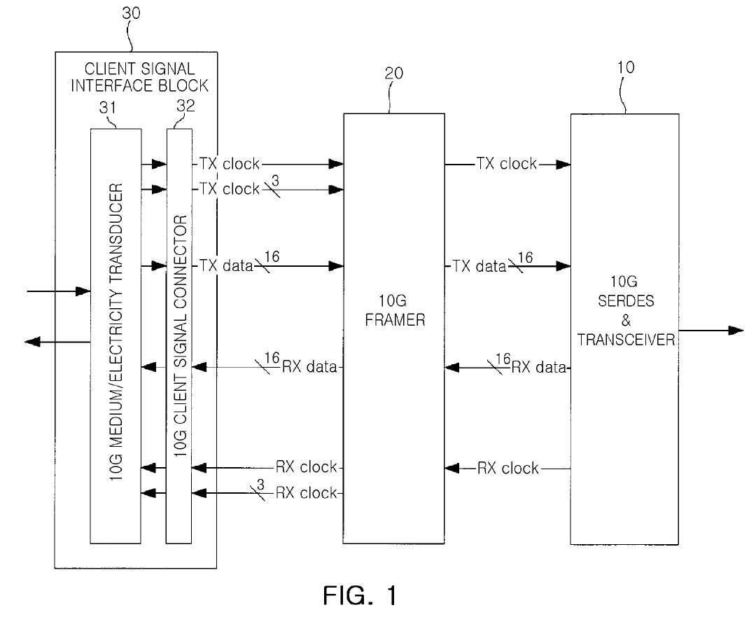

### DETAILED DESCRIPTION OF THE PREFERRED EMBODIMENT

Exemplary embodiments of the present invention will now be described in detail with reference to the accompanying drawings. For the detailed description of the present invention, descriptions of known components and their related configurations may be omitted since they are considered to make the gist of the present invention unclear.

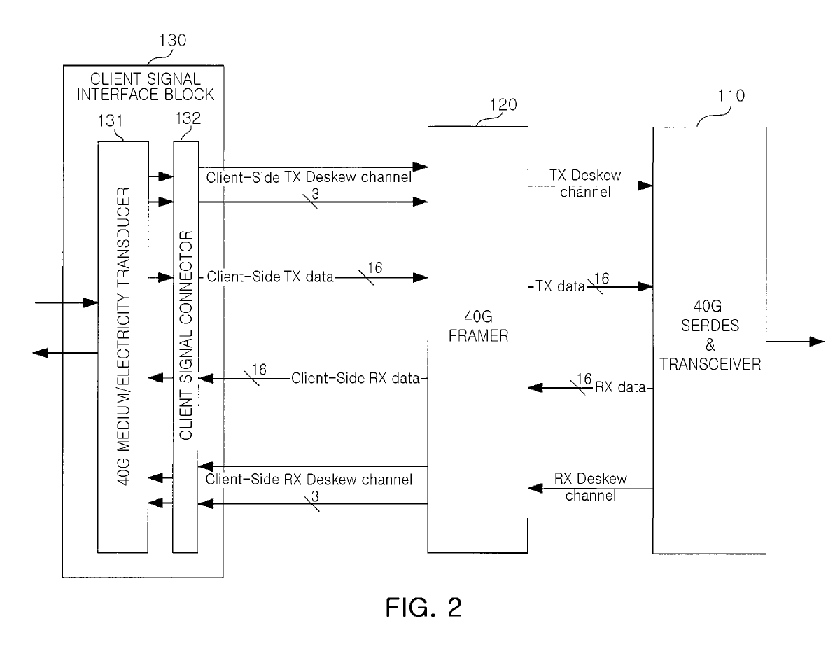

FIG. 2 is a block view illustrating a configuration of an apparatus for transmitting and receiving data at high speed according to one exemplary embodiment of the present invention which is used to transmit a data in 40 G capacity that is able to be reconstructed through 2.5 G signal connection according to various client signals.

Referring to FIG. 2, the apparatus for transmitting and receiving data at high speed according to one exemplary embodiment of the present invention may be composed of a 40 G SERDES & transceiver 110, a 40 G framer 120 and a client signal interface block 130.

The client signal interface block 130 includes a medium-electricity transducer 131 for converting client signals, being inputted through media, into a 40 G electrical client signal; and a client signal connector 132 arranged between the medium-electricity transducer 131 and the 40 G framer 120. Here, the client signal connector 132 connects a 16-bit transmission data (TX data) with 2.5 G capacity and four transmission (TX) deskew channels for transmitting a 40 G electrical client signal to the medium-electricity transducer 131; a 16-bit reception data (RX data) with 2.5 G capacity and four reception (RX) deskew channels for transmitting a 40 G electrical client signal to the framer 120. The TX/RX deskew channels have the same capacity as the transmission/reception data.

The 40 G SERDES & transceiver 110 multiplexes the 40 G multi-channel frame signal received from the 40 G framer 120 through the high-speed multi-channel into a 40 G serial signal and outputs the multiplexed 40 G serial signal, or takes its inverse operation including: receiving the 40 G serial signal in the form of electricity or other medium, demultiplexing the received 40 G serial signal to generate multi-channel frame signals, and transmitting the generated 40 G multi-channel frame signals to the 40 G framer 120 through the 16 high-speed channels.

The 40 G framer 120 transmits 40 G multi-channel frame signals to the 40 G SERDES & transceiver 110 through the high-speed multi-channel, the 40 G multi-channel frame signals being generated by multiplexing and mapping a 40 G electrical client signal, received from the client signal connector 132 through the high-speed multi-channel, into 16 data signals with 2.5 G capacity, or receives 40 G multi-channel frame signals from the 40 G SERDES & transceiver 110 through the high-speed multi-channel as its inverse operation. And, the 40 G framer 120 demultiplexes and demaps the multi-channel frame signals into corresponding client signals and transmits the demapped client signals to the client signal connector 132 through predetermined high-speed multi-channel.

Then, the apparatus for transmitting and receiving data, which is used to receive the inputted client signals from each medium by units of the maximum 2.5 G signal, the maximum 10 G signal and the maximum 40 G signal and transmit the received client signals in the form of 40 G signal, will be described in more detail.

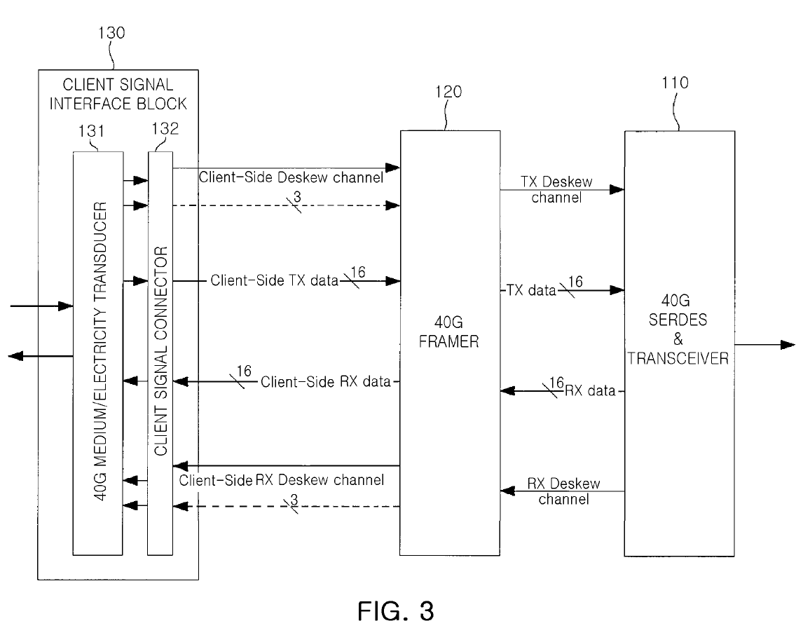

Referring to the accompanying FIG. 3, when the medium-electricity transducer 131 that employs the high-speed multi-channel by unit of the maximum 40 G signal at the client signal interface block 130 is mounted in the data transmitting/receiving apparatus through the client signal connector 132, each of 16 2.5 G data signals and one of four deskew channel signals with 2.5 G capacity are transmitted to the 40 G framer 120 according to the SERDES Framer Interface Level 5 (SFI-5) standard. Among the four client-side TX/RX deskew channels inputted into the 40 G framer 120, only one client-side deskew channel generated from one client signal interface block 130 is used, but three client-side deskew channels represented by a dotted line as shown in FIG. 3 are inactivated, and thus not used.

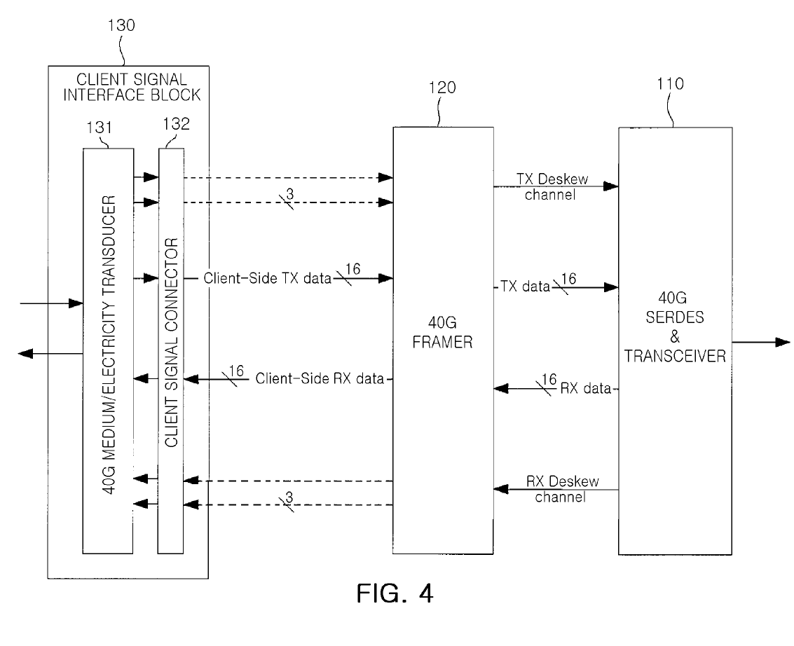

Referring to the accompanying FIG. 4, when the medium-electricity transducer 131 that employs each of the high-speed multi-channel by unit of the maximum 2.5 G serial signals is mounted in the data transmitting/receiving apparatus through the client signal connector 132, each of 16 data signals with 2.5 G capacity are transmitted to the 40 G framer 120. Four client-side TX/RX deskew channels inputted into/from the 40 G framer 120, represented by a dotted line as shown in FIG. 4, are inactivated, and thus not used.

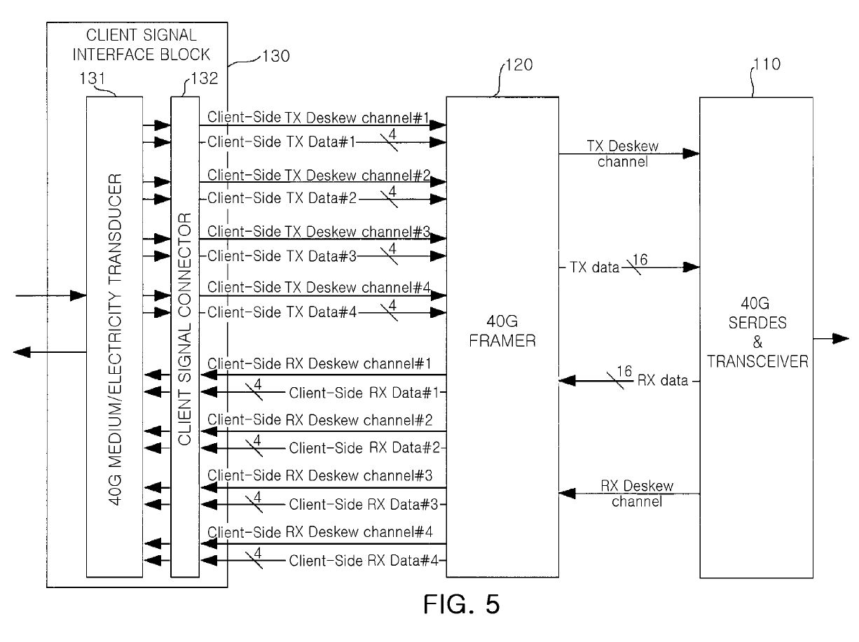

Also referring to FIG. 5, when the medium-electricity transducer 131 that employs the high-speed multi-channel by unit of the maximum 10 G parallel signals at the client signal interface block 130 is mounted in the data transmitting/receiving apparatus through the client signal connector 132, 16 2.5 G data signals and four deskew channel signals with 2.5 G capacity are transmitted to the 40 G framer 120. Each of the deskew channels is used to compensate for a skew of the four 2.5 G parallel data, as shown in FIG. 5.

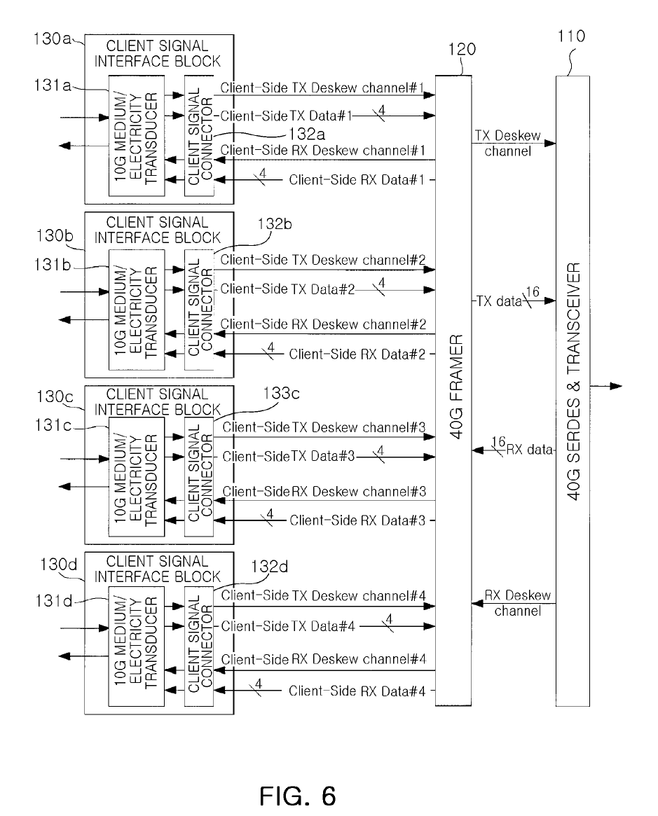

Also referring to the accompanying FIG. 6, each of the client signal interface blocks 130a, 130b, 130c and 130d is composed of medium/electricity transducers 131a, 131b, 131c and 131d and client signal connectors 132a, 132b, 132c and 132d, all of which employ the high-speed multi-channel by unit of the maximum 10 G parallel signal, and the maximum four client signal interface blocks 130a, 130b, 130c and 130d with the maximum 10 G capacity are selectively attachable/detachable to/from the data transmitting/receiving apparatus. When each of the client signal interface blocks 130a, 130b, 130c and 130d is mounted in the data transmitting/receiving apparatus, four 2.5 G data signals and one deskew channel signal are transmitted to the 40 G framer 120, and therefore each of the deskew channels is used to compensate for a skew of the four 2.5 G parallel data in each of the client signal interface blocks 130a, 130b, 130c and 130d, as shown in FIG. 6.

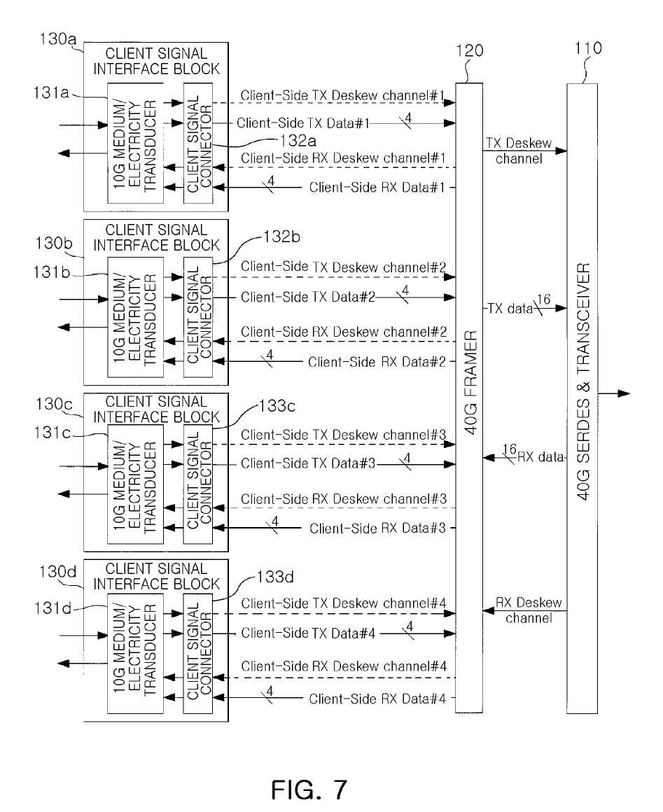

Also referring to the accompanying FIG. 7, each of the client signal interface blocks 130a, 130b, 130c and 130d is composed of medium/electricity transducers 131a, 131b, 131c and 131d and client signal connectors 132a, 132b, 132c and 132d, all of which employ the high-speed multi-channel by unit of the respective maximum 2.5 G parallel signal, and the maximum four client signal interface blocks 130a, 130b, 130c and 130d with the maximum 10 G capacity are selectively attachable/detachable to/from the data transmitting/receiving apparatus. When each of the client signal interface blocks 130a, 130b, 130c and 130d is mounted in the data transmitting/receiving apparatus, four 2.5 G data signals are each independently transmitted to the 40 G framer 120. The four client-side TX deskew channels, which are inputted into the 40 G framer 120 represented by dotted line in FIG. 7, are not used.

As described above, 16 2.5 G data and four deskew channel signals are connected between the client signal interface block 130 and the 40 G framer 120 so as to receive various client signals.

The digital transmitting/receiving apparatus for transmitting a data in 40 G capacity that may be reconstructed through 2.5 G signal connection has been described in detail in the above-mentioned exemplary embodiments of the present invention, but a digital transmitting/receiving apparatus for transmitting a data in 40 G capacity that may be reconstructed through 10 G signal connection will be described later in detail in another exemplary embodiment of the present invention.

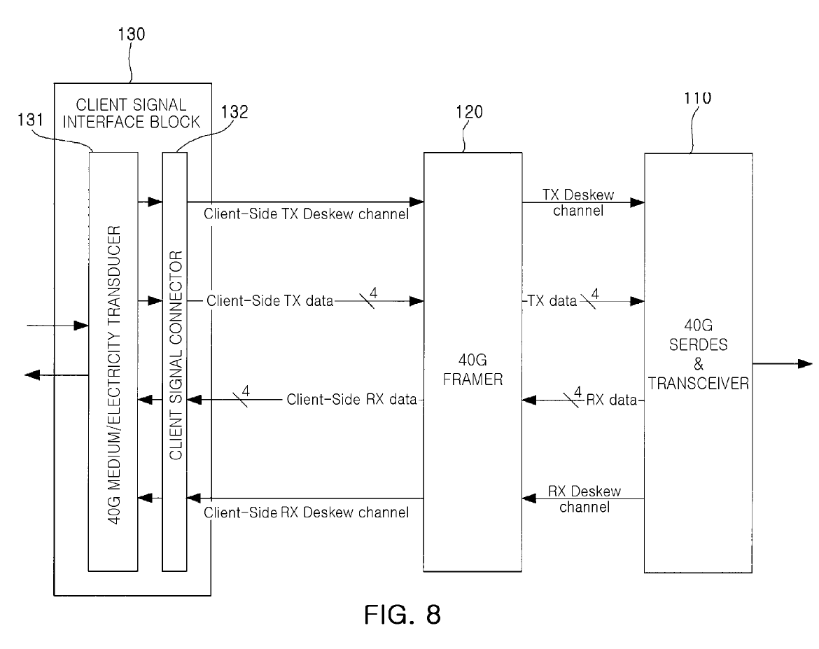

The schematic configurations of data transmitting/receiving apparatuses and the connections of their components will be described in more detail with reference to the accompanying FIGS. 8 to 11. Here, the data transmitting/receiving apparatuses function to receive client signals, which has been inputted from each of media, by units of the maximum 10 G-bit signal and the maximum 40 G-bit signal and transmit the received client signals in the form of 40 G signal.

Referring to FIG. 8, the apparatus for transmitting and receiving data at high speed according to the present invention is composed of a 40 G SERDES & transceiver 110, a 40 G framer 120, and a client signal interface block 130.

The SERDES & transceiver 110 multiplexes a 40 G signal received from the framer 120 through the high-speed multi-channel and outputs the multiplexed 40 G signal as a 40 G serial electrical signal, or takes its inverse operation including: receiving a 40 G serial electrical signal, demultiplexing the received 40 G serial electrical signal, and transmitting the demultiplexed 40 G signals to the framer 120 through the 4 high-speed channel with 10 G capacity.

The framer 120 transmits 40 G multi-channel frame signals to the SERDES & transceiver 110 through the high-speed multi-channel, the 40 G multi-channel frame signals being generated by multiplexing and mapping a 40 G electrical client signal, received from the client signal interface block 130 through the high-speed multi-channel, into 4 data signals with 10 G capacity. Also, the framer 120 receives 40 G multi-channel frame signals from the SERDES & transceiver 110 through the high-speed multi-channel, demultiplexes and demaps the received 40 G multi-channel frame signals into corresponding client signals, and transmits the demapped client signals to the client signal interface block 130 through predetermined high-speed multi-channel.

The client signal interface block 130 includes a medium-electricity transducer 131 and a client signal connector 132. Here, the medium-electricity transducer 131 converts client signals, inputted through media, into a 40 G electrical client signal, which is transmitted to the framer 120. The client signal connector 132 connects a 4-bit transmission data (TX data) with 10 G capacity and one transmission deskew channel (TX deskew channel) for transmitting a 40 G electrical client signal to the medium-electricity transducer 131; a 4-bit reception data (RX data) with 10 G capacity and one reception deskew channel (RX deskew channel) for transmitting a 40 G electrical client signal to the framer 120, wherein the TX/RX deskew channels have the same capacity as the TX/RX data, and the TX/RX data and the TX/RX deskew channels are connected between the framer 120 and the client signal interface block 130.

And, when the medium-electricity transducer 131 that employs the high-speed multi-channel by unit of the maximum 40 G parallel signal is mounted in the data transmitting/receiving apparatus through the client signal connector 132, four data with 10 G capacity and one deskew channel are transmitted to the framer 120. Therefore, the framer 120 functions to receive a client-side TX deskew channel and compensate for a skew generated in the four data with 10 G capacity, and also recover a clock and use the recovered clock as a clock for the received client signal.

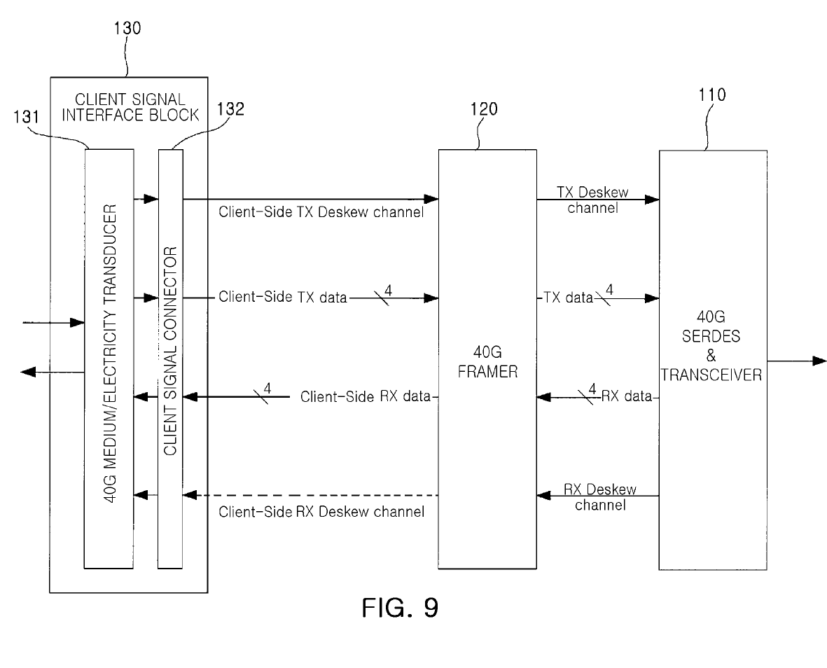

Referring to FIG. 9, when the medium-electricity transducer 131 that employs each of the high-speed multi-channel by unit of the maximum 10 G serial signal at the client signal interface block 130 is mounted in the data transmitting/receiving apparatus through the client signal connector 132, each of four data with 10 G capacity is transmitted to the framer 120. A skew is not generated since the respective data with 10 G capacity, inputted into the framer 120, operate independently from each other. Therefore, the client-side TX deskew channel inputted into the framer 120 are inactivated, and thus not used. Also, the framer 120 recovers client signal clocks from the inputted data with 10 G capacity respectively, and uses the recovered client signal clocks.

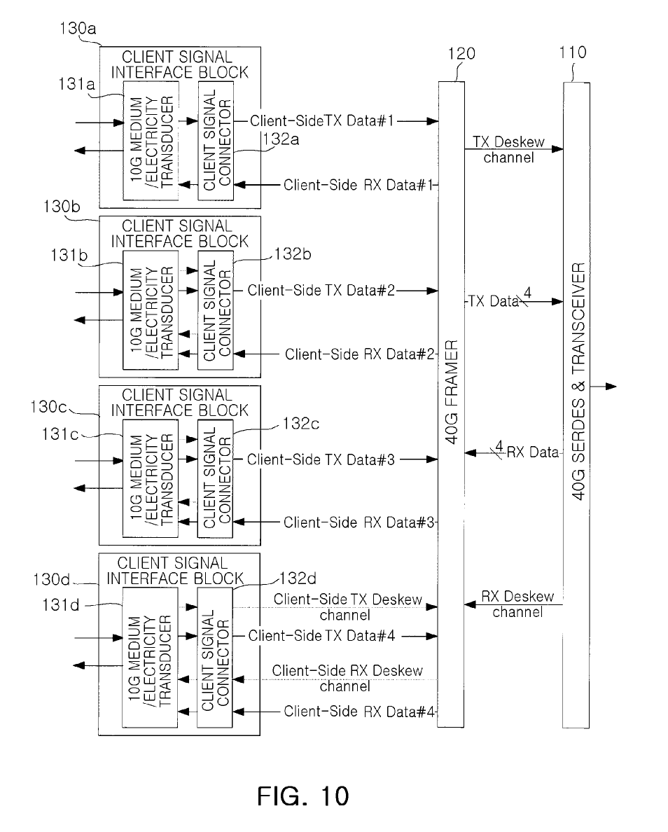

Referring to the FIG. 10, the high-speed data transmitting/receiving apparatus may include a large number of client signal interface blocks 130a, 130b, 130c and 130d, and each of the client signal interface blocks 130a, 130b, 130c and 130d is composed of medium/electricity transducers 131a, 131b, 131c and 131d and client signal connectors 132a, 132b, 132c and 132d, all of which employ the high-speed multi-channel by unit of the maximum 10 G serial signal. The maximum four client signal interface blocks 130a, 130b, 130c and 130d with the maximum 10 G capacity are selectively attachable/detachable to/from the data transmitting/receiving apparatus.

When the respective client signal interface blocks 130a, 130b, 130c and 130d are mounted in the data transmitting/receiving apparatus, one data with 10 G capacity is transmitted to the framer 120, and a skew is not generated since the respective data with 10 G capacity, inputted into the framer 120, operate independently from each other. Therefore, the client-side TX deskew channel inputted into the framer 120 represented by dotted line in FIG. 10 are inactivated, and thus not used.

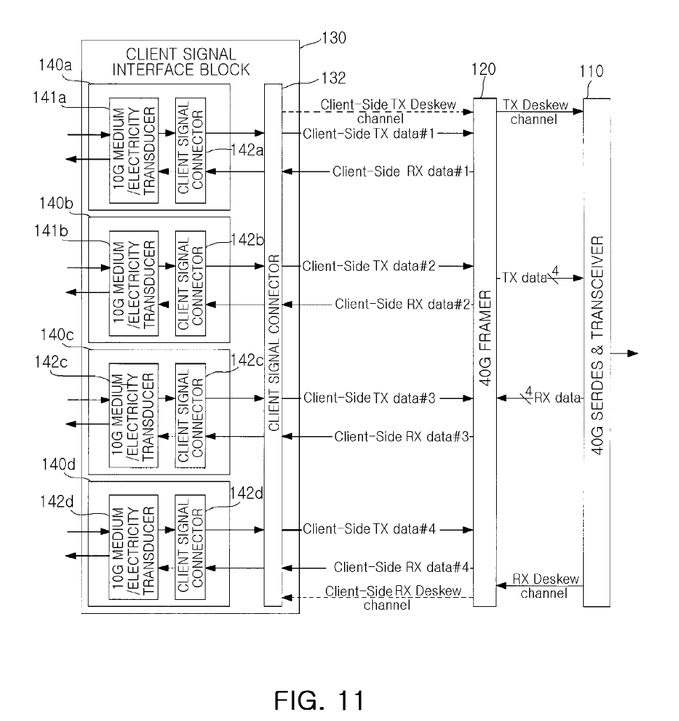

Referring to FIG. 11, the client signal interface block 130 is composed of a large number of client signal interface subblocks 140a, 140b, 140c and 140d and one client signal connector 132. Here, each of the client signal interface subblocks 140a, 140b, 140c and 140d is composed of medium/electricity transducers 141a, 141b, 141c and 141d and client signal connectors 142a, 142b, 142c and 142d, all of which employ the high-speed multi-channel by unit of the maximum 10 G serial signal.

The client signal interface block 130 employs the high-speed multi-channel by unit of the maximum 40 G parallel signal, and four client signal interface subblocks 140a, 140b, 140c and 140d employ the respective high-speed channel by unit of the respective maximum 10 G signal, and the client signal interface block 130 with the maximum 40 G capacity is attachable/detachable to/from the data transmitting/receiving apparatus to interface a client signal with 40 G capacity, and the maximum four client signal interface subblocks 140a, 140b, 140c and 140d with the maximum 10 G capacity are selectively attachable/detachable to/from the data transmitting/receiving apparatus, and simultaneously detached to interface a client signal with the maximum 40 G capacity.

When the respective client signal interface subblocks 140a, 140b, 140c and 140d with 10 G capacity are mounted in the data transmitting/receiving apparatus, each of the data with 10 G capacity is transmitted to the 40 G framer 120, and a skew is not generated since the respective data with 10 G capacity, inputted into the 40 G framer 120, operate independently from each other. Therefore, the client-side TX deskew channel is inputted into the 40 G framer 120 represented by dotted line in FIG. 11 are not used.

However, when the client signal interface block 130 is mounted in the data transmitting/receiving apparatus as shown in FIG. 8, four data with 10 G capacity and one deskew channel signal for compensating for a skew generated in the four data are transmitted to the 40 G framer 120.

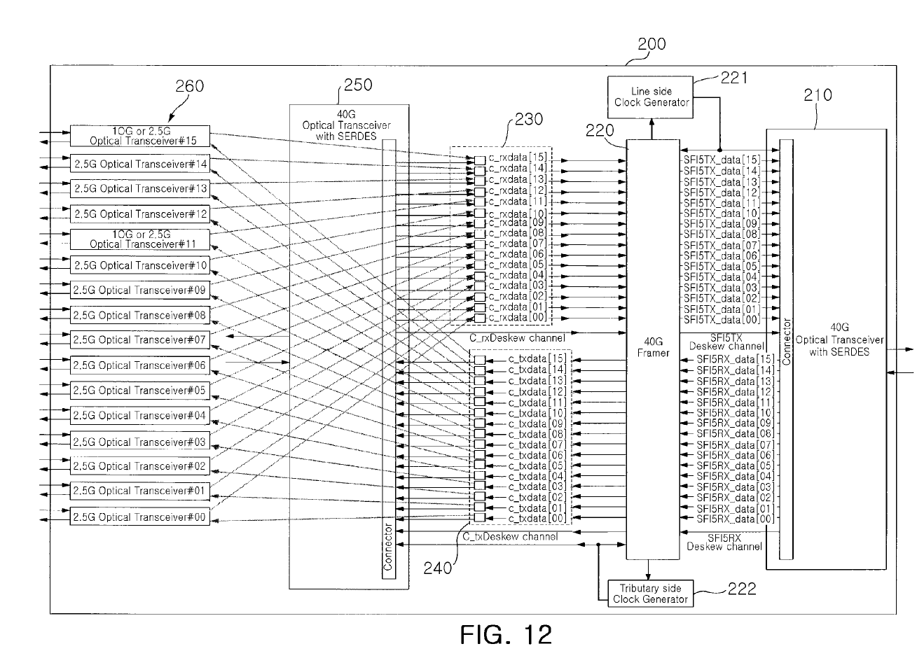

On the basis of the above-mentioned exemplary embodiments, a configuration of an optical transponder according to still another exemplary embodiment will be described in detail with reference to the accompanying FIG. 12. Here, the optical transponder receives 2.5 G, 10 G and 40 G client signals selectively, maps the selectively received client signals into a 40 G transmission frame (TX frame) and transmits the 40 G TX frame in the form of 40 G optical signal. Only one client signal interface board can be used or detachable client signal interface boards can be exchanged to receive various client signals in one hardware platform of the optical transponder.

The optical transponder 200 is composed of a 40 G optical transceiver 210, a 40 G framer 220, a selector block 230, a buffer block 240, a 40 G tributary connector/optical transceiver block 250, and tributary connector/optical transceivers 260. And, a line side clock generator 221 for generating a clock to transmit a 40 G frame to an optical network, and a tributary side clock generator 222 for generating a clock for a client signal, which is demapped from the 40 G frame transmitted to the tributary network, are connected to the framer 220.

The 40 G optical transceiver 210 includes a serializer/deserializer (SERDES) that converts a 40 G TX optical signal into a 40 G serial electrical signal and demultiplexes the 40 G serial electrical signal into 16 2.5 G parallel electrical signals, or takes its inverse operation.

The 40 G framer 220 maps or demaps 2.5 G, 10 G and 40 G client signals into a 40 G TX signal frame.

The selector block 230 is composed of 2:1 selectors, and each of the 2:1 selectors selects one of the two inputted 2.5 G or 10 G electrical signals, and outputs the selected electrical signal.

The buffer block 240 is composed of 1:2 buffers, and each of the 1:2 buffers buffers one 2.5 G or 10 G electrical signal into the two same signals and outputs the buffered signals.

The 40 G tributary connector/optical transceiver block 250 converts a 40 G optical signal, inputted from the tributary network, into a 40 G serial electrical signal, and multiplexes the converted 40 G serial electrical signal into 16 2.5 G parallel electrical signals using a serializer/deserializer (SERDES) that is included in the 40 G tributary connector/optical transceiver block 250, or takes its inverse operation.

The tributary connector/optical transceivers 260 include 2.5 G optical transceivers (#00 to #15), and some of the tributary connector/optical transceivers 260 may be used as 10 G optical transceivers (#03, #07, #11 and #15). Here, the 2.5 G optical transceivers (#00 to #15) convert a 2.5 G optical signal, inputted from the tributary network, into a 2.5 G serial electrical signal, or take their inverse operation. The 10 G optical transceivers (#03, #07, #11 and #15) convert a 10 G optical signal, inputted from the tributary network, into a 10 G serial electrical signal, or take their inverse operation.

The framer 220 may be realized with FPGA or ASIC, and transmit/receive four 10 G client electrical signals by using four of 16 output/input ports or all of 16 output/input ports since the framer 220 includes a serializer/deserializer (SERDES) that may transmit/receive a 2.5 G signal or a 10 G signal from the same output/input port.

Therefore, when the optical transponder 200 is used to receive all of 16 2.5 G client signals, all of the 16 2.5 G optical transceivers are mounted in the optical transponder, and the 40 G framer 220 is set so that 16 2.5 G serial electrical signals can be directly inputted/outputted into/from the 40 G framer 220. Also, the 2:1 selectors 230 is set so that the 2:1 selectors 230 can select an electrical signal inputted from the 16 2.5 G optical transceivers, and outputs the selected electrical signal.

When the optical transponder 200 is used to receive all of four 10 G client signals, all of the four 10 G optical transceivers are mounted in the optical transponder, and the 40 G framer 250 is set so that four 10 G serial electrical signals can be directly inputted/outputted into/from the 40 G framer 250. Also, the 2:1 selectors 230 are set so that the 2:1 selectors 230 can select an electrical signal inputted from the four 10 G optical transceivers (#03, #07, #11 and #15), and outputs the selected electrical signal.

When the optical transponder 200 is used to receive one 40 G client signal, one 40 G optical transceiver block 250 including a serializer/deserializer is mounted in the optical transponder, and the 40 G framer 220 is set so that 16 2.5 G serial electrical signals and one deskew channel signal for compensating for skews of the 16 2.5 G serial electrical signals can be directly inputted/outputted into/from the 40 G framer 220. Also, the 2:1 selectors 230 are set so that the 2:1 selectors 230 can select 16 2.5 G electrical signals inputted from the 40 G optical transceiver block 250, and outputs the selected 2.5 G electrical signals.

When the optical transponder 200 is used to receive two 10 G client signals and eight 2.5 G client signals, two of the 10 G optical transceivers (#03, #07, #11, #15) are mounted in ports for the 10 G optical transceivers, and the eight 2.5 G optical transceivers are mounted in the other remaining ports. Therefore, the 40 G framer 220 is set so that the two corresponding 10 G serial electrical signals and eight 2.5 G serial electrical signals can be inputted/outputted into/from the 40 G framer 220, and the 2:1 selectors 230 are set so that the 2:1 selectors 230 can select paths to transmit electrical signals, inputted from the two 10 G optical transceivers and the eight 2.5 G optical transceivers, to the 40 G framer 220, and output the electrical signals through the selected paths.

The 1:2 buffers 240 may select only one port, and output an inputted electrical signal through the selected port, depending on their use, or they may output the same electrical signal through two ports at the same time.

For the exemplary embodiments as described above, the transmission operation of converting an inputted client signal and transmitting the converted client signal through the framer and the SERDES & transceiver in the client signal interface block has been, for example, described in detail for convenience' sake of the description. However, it should be considered that description of a reception operation of receiving a client signal from the SERDES & transceiver to the client signal interface block through the framer is omitted since the reception operation is carried out as an inverse operation of the transmission operation.

Also, the apparatus for transmitting and receiving data with various capacities at high speed according to the above-mentioned exemplary embodiment of the present invention may be modified into 40 G and 160 G data transmitting/receiving apparatuses in the same hardware when the FPGA or ASIC that may selectively transmit/receive serial signals with 2.5 G and 10 G capacities to/from the client signal interface block and the framer is used in the data transmitting/receiving apparatus. Therefore, it is possible to realize the capacity and configuration of a new client signal to be received. In addition, when the 10 G serializer/deserializer (SERDES) is composed of 16 parallel channels as described above in the exemplary embodiments of the present invention, it is possible to interface any client signals up to 160 G capacity, as well as to selectively interface 16 10 G client signals, four 40 G client signals and one 160 G client signal.

As described above, the apparatus for transmitting and receiving data with various capacities at high speed according to the present invention may be useful to reduce its space and stably receive client signals by selectively interfacing high-speed data through the high-speed multi-channel through which high-speed serial signals may be communicated in a parallel manner, the high-speed data having various client signals with gigabit or more data capacity

Also, the apparatus for transmitting and receiving data with various capacities at high speed according to the present invention may be useful to selectively interface various client signals with attachment of only one client signal interface block regardless of the various client signals to be received to the same transmitting/receiving apparatus.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for transmitting and receiving data with various data capacities at high speed, comprising:
a client signal interface block converting various kinds of client signals being received through media into a high-capacity electrical signal and selectively interfacing the converted high-capacity electrical signal through high-speed multi-channel;
a framer receiving the selectively interfaced electrical signal and multiplexing and mapping the received electrical signal into multi-channel frame signals; and
a SERDES & transceiver receiving the generated multi-channel frame signals from the framer through the high-speed multi-channel, multiplexing the received multi-channel frame signals with the predetermined gigabit serial signals and transmitting the multiplexed gigabit serial signals.

2. The apparatus for transmitting and receiving data at high speed of claim 1, wherein the client signal interface block comprises:
a medium-electricity transducer converting the client signals received through the media into the high-capacity electrical signal and converting the high-capacity electrical signal received from the framer into the client signal; and
a client signal connector selectively transmitting the high-capacity electrical signal received from the medium-electricity transducer to the framer through the high-speed multi-channel, receiving a data signal outputted from the framer through the high-speed multi-channel and transmitting the received data signal to the medium/electricity transducer.

3. The apparatus for transmitting and receiving data at high speed of claim 2, wherein the client signal connector connects the transmitted/received electrical signals and a large number of transmission/reception (TX/RX) deskew channels for compensating for a skew between data of the transmitted/received electrical signals, and transmits the converted high-capacity electrical signals through the high-speed multi-channel.

4. The apparatus for transmitting and receiving data at high speed of claim 3, wherein the client signal interface block activates and inactivates a large number of the TX/RX deskew channels, depending on the signal capacity of the electrical signal.

5. The apparatus for transmitting and receiving data at high speed of claim 2, wherein the client signal interface block activates one of the TX/RX deskew channels for compensating for a skew between 16 data when the client signal interface block transmits/receives the 16 data to/from the framer, the 16 data being obtained by demultiplexing an inputted 40 G electrical signal into parallel data, and inactivates the other TX/RX deskew channels.

6. The apparatus for transmitting and receiving data at high speed of claim 2, wherein the client signal interface block transmits/receives each 16 2.5 G transmission/reception (TX/RX) data to/from the framer, the each 16 2.5 G TX/RX data being obtained by demultiplexing a 40 G electrical signal into 16 independent data, and simultaneously inactivates four of the TX/RX deskew channels.

7. The apparatus for transmitting and receiving data at high speed of claim 2, wherein the client signal interface block transmits/receives each four TX/RX data to/from the framer, the each four TX/RX data being obtained by demultiplexing each of the four 10 G electrical signals into four independent 2.5 G parallel data.

8. The apparatus for transmitting and receiving data at high speed of claim 1, wherein the client signal interface block comprises a large number of attachable/detachable client signal interface subblocks, each of which includes a medium-electricity transducer and a client signal connector.

9. The apparatus for transmitting and receiving data at high speed of claim 8, wherein each of the client signal interface subblocks transmits/receives one TX/RX data of one 10 G electrical signal or four TX/RX data of four 2.5 G electrical signals to/from the framer.

10. The apparatus for transmitting and receiving data at high speed of claim 2, wherein the client signal interface block activates one of the TX/RX deskew channels for compensating for a skew between the four TX/RX data that is generated when transmitting/receiving the four TX/RX data, which are obtained by demultiplexing a 40 G electrical signal into four parallel data, to/from the framer.

11. The apparatus for transmitting and receiving data at high speed of claim 2, wherein the client signal interface block transmits the four inputted 10 G electrical signals in the form of four 10 G data to the framer.

12. The apparatus for transmitting and receiving data at high speed of claim 1, wherein the client signal interface block comprises a large number of attachable/detachable client signal interface subblocks, each of which includes a medium-electricity transducer and client signal sub-connectors, and a client signal connector transmitting an electrical signal, transmitted from each of the client signal interface subblocks, to the framer through the high-speed multi-channel.

13. The apparatus for transmitting and receiving data at high speed of claim 12, wherein the client signal interface block transmits/receive one 10 G electrical signal or four 2.5 G electrical signals to/from the framer through the high-speed multi-channel.

14. The apparatus for transmitting and receiving data at high speed of claim 1, wherein the client signal interface block comprises 1:2 buffers and 2:1 selectors for selectively interfacing a signal from the same board without their detachment/attachment, depending on the received client signals.

15. The apparatus for transmitting and receiving data at high speed of claim 1, wherein the SERDES & transceiver multiplexes the multi-channel frame signal into serial signals with 40 G or 160 G capacity, demultiplexes the received serial signals with 40 G or 160 G capacity to generate multi-channel frame signals, and transmits the generated multi-channel frame signals to the framer through the high-speed multi-channel.

16. The apparatus for transmitting and receiving data at high speed of claim 1, wherein the framer multiplexes and maps the received electrical signals by unit of 40 G or 160 G signal, and transmits an electrical signal to the client signal interface block, the electrical signal being generated by demultiplexing and demapping the multi-channel frame signals with 40 G or 160 G capacity received from the SERDES & transceiver.
